(19) United States
(12) Patent Application Publication
(10) Pub. No.: US 2010/0050181 A1
(43) Pub. Date: Feb. 25, 2010

(54) Method and System of Group-to-Group Computing

(76) Inventor: Yongmin Zhang, Shenzhen (CN)

Correspondence Address: GLOBAL IP SERVICES, 7285 W. Eagle Court, Winton, CA, 95388, US

(21) Appl. No.: 12/516,408

(22) PCT Filed: Nov. 20, 2007
(86) PCT No.: PCT/CN2007/071095

§ 371 Date: May 27, 2009

(30) Foreign Application Priority Data
Nov. 29, 2006 (CN) 200610157190.3

(51) Int. Cl. G06F 9/46

(52) U.S. Cl. 718/104

(57) ABSTRACT

A method and system of group-to-group (G2G) computing, a G2G computing service system based on the portal network site, and a G2G search service system based on the G2G computing. The G2G computing is a kind of distributed computing based on the G2G network and carries a task by the group. The network comprised by the groups and related to the relation between the groups is referred to as a G2G network. The group is a collection of nodes with the same attributes. The G2G computing defines 4 basis operations: Transfer, Exchange, Node-process and Transmutation.

### CROSS REFERENCE TO RELATED PATENT APPLICATION

The present patent application is the U.S. national stage of PCT/CN2007/071095 filed on Nov. 20, 2007, which claims the priority of the Chinese patent application No. 200610157190.3 filed on Nov. 29, 2006, that application is incorporated herein by reference.

### FIELD OF THE INVENTION

The present invention relates to a method of distributed computing, especially to a computing method and system based on the group-to-group (G2G) network.

### BACKGROUND OF THE INVENTION

Distributed computing is a computer science, which studies on how to divide a problem which needs be resolved with great computing power into many small parts, then to distribute these parts to many computers to process, and finally to get a final result by synthesizing all the results from these computers.

Wherein, sharing scarce resources and balancing load is one of core ideas of the distributed computing, and utilization rate of the distributed resources is a main goal. Distributed computing is mostly implemented on the Internet, so the network communication becomes one of the scarce resources, and it is very difficult to achieve load balance in node computer groups widely distributed on the Internet.

Nowadays, the most well-known distributed computing is peer-to-peer (P2P) computing and Grid computing. For these two distributed computing, Foster pointed out that both are concerned with the same general problem, namely, the organization of resource sharing within virtual communities, that both take the same general approach to solving this problem, namely the creation of overlay structures, and that Grid computing addresses infrastructure but failure to the node failure, whereas P2P addresses the node failure but failure to the infrastructure. (Reference: Foster, I. and Iamnitchi, A. On death, taxes, and the convergence of peer-to-peer and grid computing. In 2^{nd} International Workshop on Peer-to-Peer Systems (IPTPS' 03), February 2003).

The reason why P2P computing does not address infrastructure is that the P2P system lacks of centralized management. Grid environment is usually characterized by some form of centralized management and security (for example, resource management and work load scheduling). On the other hand, scalability of the P2P system is usually better than that of the Grid computing system, because in the P2P system, resources are more dynamic and the change of appearing and disappearing of resources is faster than that in Grid. The complementary advantages of P2P computing and Grid computing may make both integrated gradually and achieve the same eventually. However, this can not prevent us from seeking new methods with many kinds of advantages and new methods of distributed computing.

### SUMMARY OF THE INVENTION

The objective of this invention is to overcome said problem of the prior art and provide a new method and system of distributed computing, that is, a group-to-group (G2G) computing method and system, which combines the advantages of P2P computing and Grid computing, and is also characterized with easy scalability and flexible infrastructure. Accurate control, high efficiency and flexibility are features of the G2G computing method.

To solve the said technological problems, this invention provides a new method of distributed computing, that is, the G2G computing. First of all, some related concepts are explained as follows.

The computer network refers to a system in which many computer systems with different locations and independent functions are connected through communication equipment and lines, and then resources can be shared in the network through the network software with perfect functions. A processing unit with the computing function in the network (such as computers, communication equipment and so on) is referred to as a node.

The group is a collection of nodes with the same attributes. There are one or more node members in a non-empty group. The group transferring contents is referred to as the transfer group, and the group receiving contents transferred by other groups is referred to as receiver group.

Attributes of the group can be contents, tasks, network rate, location, distance, delay, node identification, stability (on-line time, packet loss rate), and location of starting to receive contents. Included but not limited, any other attributes related to tasks, behaviors, individual difference, and identification can also be attributes of the group. Attributes can be multi-selected. Attributes preset to be no longer subdivided are referred to as basic attributes, whereas attributes with more than two basic attributes are referred to as composite attributes.

The network constituted by the groups and related to the relation between the groups is referred to as a G2G network. Distributed computing based on G2G network is referred to as G2G computing.

As the group is characterized by multi-nodes, many-to-many network transfer can be replaced by G2G network transfer. Many-to-many network transfer can greatly increase efficiency, but it is very difficult to be implemented. Replacing many-to-many transfer with G2G transfer is the beginning of attempting to solve the problem. The primary “many” is arbitrary or disorganized, whereas groups can be established with attributes, which means an organized “many”. It is an effective method of changing arbitrary “many” to regular “group”.

Here, using the name of G2G computing instead of group computing is to emphasize that there is equal importance between inner-group computing and cooperation scheduling and processing among groups.

G2G transfer is the basis of the G2G computing. Let's see how G2G transfer works.

G2G transfer principle is that contents that need to be transferred are divided too many blocks, and many nodes involved in transferring contents are grouped to many groups, and some or all members in the transfer group get involved in said content block distribution, and the distributed content blocks are respectively transferred by said members to some or all members of the receiver group in need of contents, and the content blocks transferred from said codes are exchanged again by members of the receiver group to other members in the group.

It is known from G2G transfer principle that there are two kinds of transfer for G2G transfer, that is, inter-group transfer and inner-group transfer. To distinguish these two transfers, the concepts below are for reference.

Transfer means a transfer group transfers content to another receiver group. Specifically, contents that need to be transferred are divided too many blocks, and many nodes involved in transferring contents are grouped to many groups, and some or all members in transfer group get involved in the said content block distribution, and the distributed content blocks are respectively transferred by said members to some of or all members of receiver group in need of contents.

Exchange means within a group, members transfer contents with each other. Specifically, the content blocks transferred from said nodes are exchanged again by members of the receiver group to other members in the group. Some data which belong to some nodes but need to be open to other nodes can also be transferred to other nodes through Exchange.

Said contents include data, programs and information (for example, execution and query command).

Exchange is the inner-group transfer which takes place among members with the same attributes, so the network communication environment should be comparatively looser. Transfer refers to the inter-group transfer, which is possible to become a bottleneck problem of transfer. Therefore, in G2G network transfer, the differences between Exchange and Transfer should be fully considered.

FIG. 2 is a schematic diagram of G2G transfer from a transfer group to a receiver group, as arrows point forward. The polygon stands for a group and inner-group exchange. The ellipse stands for transfer, which is a many-to-many (i*j) connection. “i” stands for the number of transfer group members involved in transfer, and “j” stands for the number of receiver-group members involved in receiving transferred contents. Assume that the total number of transfer-group members is M, and the total number of receiver-group members is N, and then i≦M, j≦N.

The combination number of many-to-many (i*j) connection of transfer is V=2^{M}×2^{N}.

The combination number above indicates that connections of transfer can be arbitrary, so the better schemes can be selected out from arbitrary connections. However, selecting the best scheme is difficult because of the huge combination number of connection. Therefore, many-to-many connection is highly effective but difficult to implement. Fortunately, there is G2G transfer principle.

Exchange is not necessary. Members in a receiver group without exchange receive data totally relying on transfer of the transfer group. With inner-group exchange, G2G transfer is referred to as G2G transfer with exchange. Let's see how inner-group exchange works. (See FIG. 3)

FIG. 3 is a schematic diagram of G2G transfer showing how exchange works in groups. In some transfer group, there may be one or more nodes, which transfer the distributed contents to the receiver group, and the receiver group can also be a new transfer group after receiving contents. Through exchange after transfer, a content stream can become N content streams, that is to say, exchange can achieve amplification effectiveness.

Exchange mentioned above only refers to exchange of received contents, not including inter-transfer of private information among nodes in groups. A group usually has a unique identifier, and all or most member nodes in groups usually hold status information of groups. So it is very easy for inter-transfer of information among nodes in groups, and this kind of transfer is referred to as private information transfer. Easy private information transfer is a natural characteristic of G2G computing.

For better implementation of the G2G computing, the method of G2G computing in this invention comprises four basic operations below.

1, Exchange;

2, Transfer;

3, Node-process: process to tasks on nodes, which refers to specific job of nodes about the G2G computing. Node-process can complete tasks assigned by the group to member nodes, including processing use of contents received by this node, such as information archiving or information presentation to users. Generally, there are two modes to arrange Node-process. One is the job assigned by job scheduling, and the other is the job set by users, such as video program selection by users to watch. Job programs can be transferred by job scheduling appointment, and can also be local program resources of nodes.

4, Transmutation: obtaining new information according to processing on received information. The computing result of a task is Node-process results of each node through Transmutation.

As shown in FIG. 2 and FIG. 3, information can be continuously transferred to next group, but what some receiver groups need is some processed information. For example, what a receiver group needs is video contents processed on source video contents in the way of “fast forward”, so instead of unnecessarily transferring the whole source video, the transfer group just needs to transfer processed video contents to the receiver group (the transfer amount can be greatly reduced). This kind of processing is referred to as Transmutation.

With 4 basic operations mentioned above, it is easy to build up desired G2G computing. One example is the called P2P IPTV (Internet Protocol TV), in which the transfer group consisting of one or more servers with content resources transfers the contents to the receiver group in need of contents, and the receiver group expands the scale of users through Exchange. Meanwhile, some groups which can be both receiver and transfer groups can continuously transfer the contents to next group, and some groups can also process Transmutation on contents, and then transfer them to next group. Finally, video contents are available to nodes through Node-process.

Transmutation in IPTV system is not limited to simple process on received information, and it can also be a kind of summary, such as returning satisfaction degree of inner-group users with video contents, or possibly voting or voting rate. What's more, Transmutation is related to information receiving and each node-process. The function model of Transmutation is

Transmutation (R, C, {pᵢ|pᵢ εNode-process}).

R is the parameter of requesting portal, C is receiving contents, and pᵢ is No-process of node i.

Certainly, not limited to be applied to IPTV, the G2G computing can be widely applied. For example, in a distributed storage system, contents in need of being stored can be transferred to the target nodes, and Exchange and Node-process may be needed, and then respective contents can be stored by the nodes. When contents need to be extracted, contents needed are obtained by cooperation of Node-process and Transmutation, and then the contents are transferred by nodes to appointed users.

It can be seen from examples above that code-process focuses on individual processing. There can be different node-process on each node, and node-process can also be multiple. For example, Node-process in IPTV can be a media player, and it also can be a personal video recorder (PVR). Also, Node-process is different in different G2G computing systems. For example, Node-process in a distributed storage system relates to storage, index and so on.

Results of Transmutation can be data sets. Transmutation operation can be processed before transfer, which means each node processes a part of Transmutation operation. Transmutation operation can also be processed after results or status of Node-process is returned to appointed groups or nodes.

As parts of Transmutation operation or results of Node-process that need to be transferred are processed on nodes, by pre-set methods, such as immediate transfer or wait command transfer, asynchronization or synchronization etc., parts of results that have been computed are transferred by each node to the output group or to next assigned (computing) group as new contents. Transfer and Exchange can apply to transferring results of no matter Transmutation or Node-process.

Transmutation focuses on group processing, which can be transferred through Transfer to the output group or next group. Based on this, Pipelining Distributed Computing Network can be built, in which many Node-processes each process corresponding computing, whereas Transmutation focuses on group's stage results, which are then transferred to next group for the need of next level computing. Wherein, output of Transmutation can be asynchronous or dispersive, that is, data having been processed by Node-process can be transferred according to the scheduled policies to some or all members appointed by the receiver group. Transmutation can also be a group of learning programs, which make the G2G computing become a learning network.

A brief summary of Transmutation is as follows.

1, Transmutation operation is to transmute contents (such as abstract, segment, reworking), or to obtain information related to contents.

2, Transmutation operation is a result operated by groups according to input contents (data) and Node-process of each node.

3, Results of Transmutation operation can be data sets. Contents that have been computed are automatically transferred by each node to transfer group or to next assigned (computing) group as new contents.

When the number of members in the receiver group in IPTV is too large, these nodes can be grouped to many receiver groups, and the transfer group can transfer contents to many receiver groups at the same time. This transfer method is flexible due to the G2G grouping.

As long as based on attributes, the G2G grouping can be unrestricted, even repetitive. For example, three adjacent schoolmates, who once studied in the same primary school and high school, can be grouped into G1, which is a group of adjacent primary schoolmates, and G2, which is a group of the adjacent high schoolmates. The member collection of G1 and G2 is same, but different in some attributes. Grouping can be repetitive. It should be noticed that it is very difficult or even impossible to seek for the best combination. Therefore, appropriate condition restrictions need to be introduced, and also some effective and flexible grouping rules applicable for the G2G computing as follows should be employed.

A1, the first precedence is task precedence. Different groups are created for different tasks.

B1, the second precedence is task running status precedence. For some tasks need a long time to be completed and during this process, nodes may be interrupted. When users re-join in or adjust, grouping needs to base on completion status of the task.

C1, the third precedence is other attributes precedence, which including (not limited to)

C11, the network speed precedence, for in many applications, network speed is a very important attribute.

C12, the resource attributes precedence. For some parts of the G2G computing, a clearly aware of all kinds of resource conditions of nodes such as CPU processing power and storage capacity is needed and used as rules of grouping.

C13, the stability precedence, that is, grouping is based on stability of previous network connection (including on-line time, packet loss rate, etc.).

C14, the location precedence, that is, the location of nodes is judged based on IP address, and nodes in the same location are grouped into the same group with priority.

C15, the delay or distance precedence, for distance is usually measured through arrival time.

C16, the same node identification attributes precedence. For example, nodes with identification of neighbor according to Distributed Hash Table are grouped into the same group.

D1, when grouping according to policy A1, B1 and C1 mentioned above, the number of group members can not be larger than a number preset by the system, and a new group can be created if necessary, and there can be many groups with the same attributes.

Actually, A1, B1 mentioned above can also be a kind of attribute partition. One or more rules can be selected.

Based on the policy D1, a flexible, load balancing and easy-scalable system can be built.

For satisfying the need of some computing styles, without changing the original group, members of a group can be grouped to many groups, which are referred to as sub-groups.

Another advantage of the G2G computing is that some nodes with the same attributes or tasks can be grouped into the same group. This can solve problems within the group, that is, there will be more related information of inner-group members, private information transferring, and Exchange can also be completed in the group.

Similar to process in programs, Node-process of each node in the group can communicate with each other. Based on this, computing tasks on a data set can be concurrently executed by Node-process. Similarly Node-process has three status, execution, block and ready, to make a task be cooperatively processed by Node-process of many nodes.

Finally, G2G computing benefits from many-to-many (i*j connection) connection among groups. Compared with super routers or super nodes, the connection manner of G2G is obviously more efficient.

Information of a node is needed for knowing it. In a group, there will be some information related to nodes and tasks, and also identification information related to the group to distinguish if there are many groups. All this information is referred to as information of the group. If unnecessary to look up each node, information related to a group can be known from only a data table, and this kind of groups is referred to as information-form groups. Said data table can be obtained by one-step, such as a control data set being stored in each node or a management server, or by fewer steps, such as within log (N).

Not all groups are information-form groups, such as broadcasting-form network, in which specific information of receiver groups needs not be known. There are also some groups which do not or can not establish group information, such as groups consisting of all nodes in one location. Non-information-form groups usually obtain related information through discovering nodes.

That a data table can be obtained by one-step mentioned above means that a data table, which is stored in each node or a management server can be obtained through only an operation of extracting data. That a data table can be obtained by fewer steps means that with a hierarchical structure in a group, a data table is separated to some sub-tables which are stored in some sub-groups, and data tables in these sub-groups are gathered to form the information data table of the group.

To distinguish information (contents) input, a data table reflecting group information is also referred to as a control data set. Groups with information are more operable, so we mostly focus on information-form groups. For convenience, all groups discussed are information-form groups unless some are specially pointed out.

As a matter of fact, many operations of a group are based on the control data set. For example, grouping or changes of status can be reflected in the control data set. The control data set comprises identification, attributes, policies, tasks, status of groups, as well as one or a collection of more than one of resources, attributes, necessary data for inter-communication, node tasks, transfer status and task status of each node. FIG. 4 shows an example of a control data set application. Necessary communication data brought by users joining, grouping information and task information and so on are added into the control data set. Existing of other users, changes of communication status and task status should also be reflected in the control data set in time.

With information of a group (a control data set), the G2G computing can be easily implemented by supporting grouping and group management, supporting G2G transfer, such as transfer scheduling and congestion control, and supporting job (load) scheduling.

Job scheduling is very important for distributed computing. Scheduling programs is finally designed to assign tasks onto resources of each node for execution, so comprehensive and timely information becomes necessary. Based on the control data set, how many resources there are and the resource distribution situation can be know exactly by G2G for implementing convenient and effective job scheduling. Assigning tasks can notify each member node through the control data set. Generally, when tasks are assigned though Transfer and Exchange, different Node-process should be assigned to each node to process different computing, and then computing results are returned through Transmutation.

Illustration of a control data set in FIG. 4 shows that the G2G computing can well adapt to real-time changing dynamic environments. Joining in and existing of users, status changes of communication and tasks can all be reflected in the control data set in time, which make real-time job alteration be possible, therefore, the G2G computing can make real-time transfer scheduling (alteration) and job scheduling (alteration).

Generally, a transfer group should also possess information of the corresponding receiver group for more convenient and flexible transfer scheduling and job scheduling. Depending on the control data set so much, in some degree, G2G computing can not operate without it, which makes the G2G computing with certain management power.

Using a control data set doesn't means centralized management. For example, when many nodes request the same contents from one node, the node can establish a control data set to assist content transfer, which can not be regarded as centralized management. This kind of management is without central nodes, but with consistent control, transfer scheduling and job scheduling is also one of the characteristics of the G2G computing.

Security of G2G computing can also be improved by using a control data set, because nodes involved in the G2G computing are members in a control data set, so with enough protection for the control data set, spreading of destructive programs like attack from hackers and viruses can be prevented. With user validity checking, applied security can be achieved at a lower cost.

Regarding confidentiality, the G2G computing also works well. For medium confidentiality, symmetric encryption algorithm can be adopted, because groups are involved and passwords are generated along with group dynamically, which can possess higher confidentiality than in static or seldom changing environment. For high confidentiality, asymmetric encryption algorithm can be adopted, or encryption task can be completed by getting public key or private key through the control data set.

To solve the technological problems above, this invention also provides a G2G computing service system based on the G2G computing system. There is at least one machine-readable medium, which possess machine-readable program code logic for implementing G2G computing service, the structure of which comprises four layers on the computer network, as indicated in FIG. 1 as follows.

Management layer is assigned to manage group information. Based on a control data set, this management includes user joining in and exiting out, changes of communication and task status, and also update of control data sets of groups and nodes.

Support layer comprises four basic operations of G2G computing: Transfer, Exchange, Node-process and Transmutation, and provides strong support for G2G computing.

Scheduling layer is assigned for transfer scheduling and job scheduling. Generally, a control data set is directly used for transfer scheduling and job scheduling, and information monitored can also be returned to transfer scheduling and job scheduling.

Application layer comprises several kinds of specific applications running on the G2G network implemented by development tools, application programs, and services, such as distributed computing (applied in science research, finance and so on), streaming media, content and file sharing, as well as communication and cooperation systems.

The G2G computing service system based on the G2G computing is described as follows.

As a matter of fact, any node can be assigned to manage a G2G computing, that is, management of the G2G computing can be dispersed. But as dispersed management is usually low efficient, centralized management, and also hierarchy management, should be adopted necessarily in many cases.

For example, there can be an authentication server for user authentication, storage of user certificates, and management modules, a resource manager for management of a variety of resources, as well as transfer scheduling devices, job scheduling devices, group managers and so on in the G2G computing system. These logic servers can run on one or more physical servers, or, a physical server can operate many logic servers or logic modules. However, a logic server can also run on many distributed physical servers. For example, some specific groups can carry their own independent group management servers, and meanwhile it is also possible for an upper-level group management server is existed to manage sub-level distributed group management servers.

Further more, adopting centralized management is providing G2G computing through Web or user portal network site. The main function of adopting Web service to provide the G2G computing is to provide portal service of the G2G computing to users, with functions of submitting interactive tasks, as well as result query, information query, file or directory management, uploading, downloading and some regular application functions. It can also provide some tools and services.

Based on the portal network site, customized computing portals can be provided to lead users to complete G2G computing running of programs only by inputting parameters. This invention also provides a G2G search service system based on the G2G computing.

As a matter of fact, a G2G search service is a search service with G2G computing service structure. Firstly, it adopts the G2G computing method and a G2G system structure with four layers comprising four G2G basic operations. Then it provides users with portal service of the G2G computing through the portal network site, with a function of submitting interactive tasks. Finally, it provides users with all kinds of search services.

In the G2G search services, once accessing the portal of the G2G search service, users access a cooperation search environment. The cooperation search can be various, including

A2, forming a search task group together with other users with the same need of searching;

B2, carrying search services for the search system;

C2, requesting search services.

In item A2, many users form a search task group. With allocation of a part of tasks therein for each user, the workload of each user can be reduced, and a very wide range can be searched. However, not every search request needs distributed search, and needed information can also searched out from the center server. Meanwhile, grouping is still valuable, which can distribute searched contents to all members by means of G2G.

In item B2, when users are on line, the search service system assigns search tasks according to node capacity and pre-convention. The user on-line refers to time of participating in the search, which can also be preset. For example, it can be preset to all time periods or some specific one during users' connection with the network, or to a time period from users accessing the portal to exiting. Searching results can be returned to the appointed servers, or be transferred to appointed users or receiver groups after Transmutation operation.

Similar to G2G computing based on the portal network site, for encouraging users to carry search services, the G2G search service system can also adopt a method of encouraging, such as providing users carrying more search services with higher priority to use the G2G search services.

The search services carried by nodes are better to be combined with the local (desktop) searches of the nodes. These local searches can be an inherent part of the search system, and can also call the third-party local search engines already owned by the nodes.

In item C2, users can request search services by default manners as well as appointed manners. The default manners can be that the system, based on the specific circumstances, arranges searching out the needed information from the center server (information in the center server may also be the results of previous distributed search), or implement further distributed searches.

What the G2G search service brings to us is as follows.

Firstly, the G2G search service has basic characteristics and advantages of distributed searches, which include reduced investment on hardware, searching without restrictions of Web services bottleneck, that being free from the restrictions on file format, searches can arrive a depth that the traditional directory-style search engine can not arrive can be obtained, and not only monopolized information but also original information can be obtained.

Secondly, the G2G computing of the G2G search service brings new benefits as follows.

1, Even for centralized management search, G2G transfer can be adopted to accelerate distribution of searched contents and reduce the need for server bandwidth.

2, Even for centralized management search, idle distributed resources can be used to associate search and return the results to the center server.

3, DHT is just an attribution selection of the G2G computing, and the G2G computing itself carries the distributed network of structured topology, which can solve some problems of DHT such as supporting only query by accurate keyword matching, not complex queries like content or semantics. That is, the G2G search can be arbitrary, including searches by contents or semantics.

4. The length of network link and the parameter degree are two important parameters of the structural P2P network search technology. The parameter degree represents neighborhood correlation numbers or routing table capacity, and link length represents the average path length of search algorithm. The relationship between the parameter degree and the link length is a progressive curve, which means that a larger link parameters degree can reduce the link length. As the parameter degree, the scale of the control data set of the G2G computing is a relatively flexible, and it can complete search in a shorter link length, which can help accelerate search.

5, The G2G computing is a system with a system structure, so the G2G search service based on the G2G computing can make grouping cooperative search according to different attributes of nodes, which can bring higher efficiency. Additionally, many information databases related to groups can be built to help locating search.

In G2G search, there can be different solutions in different circumstances. For example, when users request search service, the system group users based on same requests, and here, many independent task requests of a user can join in many groups, and then according to tasks the system can query the results Cache that recently searched by other users, or in the information server, or through distributed search.

Query results can be returned to the users by G2G transfer. In the results returned to the users, there are usually many sub-items for users to select, such as contents A, B, C in the returned results for selection. The users with different selections can also be grouped again respectively, and different groups transfer respective contents to the users which belong to the groups through G2G.

Said result Cache is a collection of searched contents that have been recently requested by users to the G2G search service and returned with results. Result Cache has a time limit, and if there are no desired contents in result Cache, other policies will be further adopted for query. Query from result Cache can reduce or avoid the same query.

Result Cache, which is not limited to specific storage modes, can be computer memories, hard disks, as well as other storage systems.

There will be different policies for requesting the query task group to make query, which can be set by users or adopted by the system depending on different situations. Results returned can consist of results from many queries, including results from the result cache query, from the information server and through distributed search.

As carrying tasks, users can also make different actions. A relatively simple one is query among inner-group members. The secondary is that the search system may sends out query on local contents of nodes to all or related groups. During search, queries can be sent out one by one, or by broadcasting (group sending in the way of G2G), or combination with group information. For example, provided that there is group 1 for sport programs, group 2 for news programs, and group 3 for comprehensive programs. When a user wants to search football program A, he can send out query to all members of the three groups at the same time. He can also send out query to group 1 firstly, and if there is no football program A, he can send out query to group 2 and group 3, and usually football program A can be found in group 1. It can be seen that based on group information, a lot of things can be done. Or beyond P2P, combining with a large amount of existing sophisticated information search and data mining leads to a new world of searching.

Another way of carrying tasks is that nodes carry search tasks assigned by the search system. These search tasks are not limited to local search of the nodes, and the nodes can make search outward. For example, after planning a search space and specifically sub-allocating a search task, the search system assigns members in a group to make search depending on respective search spaces and tasks, and through group management, group members can process tasks with cooperation of other members. Nodes in a search space can be extensive, members in some group in the search system are not necessarily, and nodes may work like some common network robots.

Results of carried task search can be transferred (in G2G way) to assigned task groups directly.

Results of carried task search can be returned to the center server wholly or after processing. Or only corresponding index is returned, with search results saved locally to form a distributed storage network.

The network consisted by the groups and network related to the relation between the groups is referred to as a G2G network. The group is a collection of nodes with the same attributes. Therefore, the G2G network is a network structure most appropriate for searching, which can be embodied in following respects.

1, a group is a kind of classification, and the G2G network is a classification network, which is a network structure constitutionally appropriate for searching.

2, the G2G network has not only a group-to-group equal reticular structure as a main structure, but also a layering structure based on sub-groups as an assistant, which is a flexible structure as an replacement of the grading/super node network. With this kind of structure, the G2G network can build a distributed search route more easily.

3, there can be many attributes of nodes, that is to say, nodes can belong to many groups, and to some extent, attributes can be regarded as optional. Then the G2G network can form various flexible information networks. For example, a kind of semantics covering network based on the G2G network structure can be built.

4, the G2G network is especially appropriate for dynamically changing network environments, in which e.g. users enter and exit at any moment.

As mentioned in the introduction, one trend of P2P search development is to develop an interest relationship network, which is just what the G2G network does well in. Users with the same or similar interests are grouped, and then form an interest relationship network. With such G2G interest relationship network, it can be easier to search some information interested in.

More interestingly, a large amount of mature information search and data mining can be applied in the G2G network. For example, DHT technology can be adopted, and also hybrid techniques that there is a unique DHT identifier for each group, while flooding or broadcasting technology is also adopted in the groups.

A G2G search based on the portal network site adopts a topology of partial centralized index. With the traditional centralized search engine functions, this kind of G2G search adopts partial centralized index, which is conforming to the trend. In fact, the group is the index.

The centralized degree of the index of G2G search is different for situations. The index mainly contains group information, and also information of each node. Contents of the index can be simple in order to avoid legal risks. For example, it contains only necessary data for node communication, and can also be interest relationship network. Contents of the index can also be complex. For search convenience, there is much additional information related to groups or a lot of index for each group, and can even be a semantics covering network.

Therefore the benefits of this invention are as follows.

1, In this invention, tasks are processed by the group to avoid the same repetitive computing. Another advantage is that, returning results to users through G2G transfer can reduce the need for server bandwidth and accelerate transferring.

2, The G2G search service built according to this invention has the basic characteristics and advantages of distributed search, which include that investment on hardware can be reduced, that users can make searches without restrictions of Web services bottleneck, that being free from the restrictions on file format, searches can arrive a depth that the traditional directory-style search engine can not arrive, and that the original information can be got, not only monopolized information but also the original information can be obtained, that G2G transfer can be adopted to accelerate distribution of searched contents and reduce the need for server bandwidth, that idle distributed resources can be used to associate search and return the results to the center server, that searching keywords need not be accurately matched, that the G2G search can be arbitrary, including searches by contents or semantics are included, and that it can help accelerate searching.

The characteristics and advantages of this invention will be illustrated in detail through embodiments with attached figures.

### BRIEF DESCRIPTION OF THE DRAWINGS

FIG. 1 is a schematic illustrating a system structure of the G2G computing in this invention;

FIG. 2 is a schematic diagram showing a kind of G2G network transfer according to the present invention;

FIG. 3 is a schematic diagram showing a kind of G2G network transfer (Exchange) according to the present invention;

FIG. 4 is an illustration of a kind of grouping and a control data set;

FIG. 5 is a block diagram of an embodiment of a kind of G2G computing service structure formed by the G2G computing according to the present invention;

FIG. 6 is a block diagram of an embodiment of a kind of G2G search service structure formed by the G2G computing according to the present invention;

FIG. 7 is an illustration of an example of a user accessing task groups according to the present invention;

FIGS. 8-1, 8-2 and 8-3 are flowcharts of job scheduling in an embodiment of a kind of G2G computing service structure formed by the G2G computing according to the present invention;

FIG. 9 is a flowchart of an embodiment of a kind of G2G computing according to the present invention;

FIG. 10 is a flowchart of query request execution in an embodiment of the G2G search service structure formed by the G2G computing according to the present invention.

### DETAILED DESCRIPTION OF THE PREFERRED EMBODIMENT

The environment of this invention is the computer network. For example, groups comprise nodes on the computer network. Nodes are processing units with computing function on the network, such as personal computers (PCs), palmtop equipments, multiprocessor systems, programmable consumer electronics based on micro processor, network PCs, micro computers, desktop computers, portable computers, consumer application equipments with microprocessor or microcontroller, routers, gateways, HUB or similar equipments.

This invention can also be implemented in distributed computer environments, in which a task is executed by the nodes linked through wired or wireless network. These nodes, such as remote processing equipments or device, can be those specifically built for special purpose, or all kinds of general machines operation with computer programs developed according the theory presented in this application. In distributed network environments, programs can be stored locally or in remote storage devices.

This invention can also be presented as machine-readable codes in machine-readable medium, which will be thought to be any mechanism of storing and sending information in machine-readable way. For instance, the machine-readable medium includes read-only memory (ROM), random access memory (RAM), magnetic disk storage medium, optical storage medium, flash storage device, transmission signals of electrical, optical, acoustic or other forms (such as carrier wave, infrared signal, digital signal, etc.)

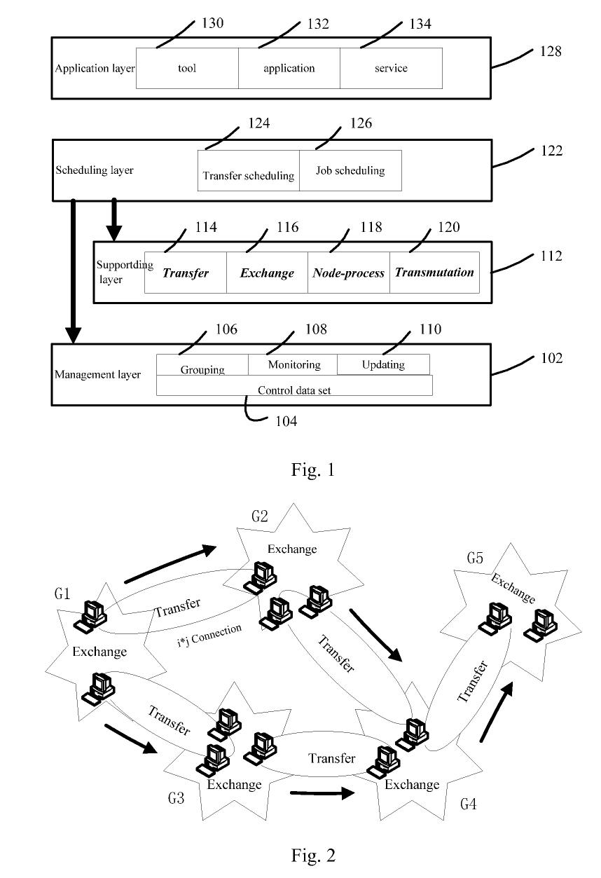

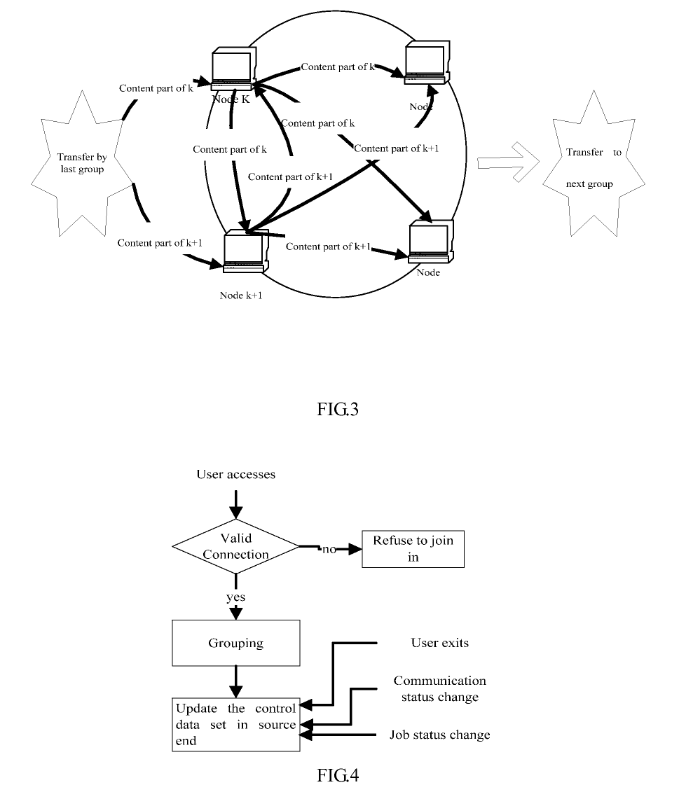

FIG. 1 illustrates a system structure of the G2G computing, which divides the system into management layer 102, support layer 112, scheduling layer 122 and application layer 128.

There is a grouping module (frame 106) responsible for group management of users in the management layer. Specifically, when logging on, a user accesses a specific group through grouping, and when attributes of the user change, one needs to alter the group it belongs to, which is also executed through grouping. Said attributes changing is recognized through a monitoring module (frame 108). Monitoring can be periodicity query, and also a single event query, as well as all kinds of feedback information such as QOS.

Information from grouping and monitoring is recorded in group information, that is, the control data set (frame 104), which provides direct support for support layer and scheduling layer. An Updating module (frame 110) is in charge of updating the control data set of the related groups and specific members. The control data set can be stored in each node or in a management server so that group members can get the control data set by only one operation.

Support layer provides computing basis for the G2G computing with 4 basic operations, including Transfer (frame 114), Exchange (frame 116), Node-process (frame 118) and Transmutation (frame 120).

Transfer means a transfer group transfers content to another receiver group. Specifically, contents that need to be transferred are divided too many blocks, and many nodes involved in transferring contents are grouped to many groups, and some or all members in transfer group participate in the said content block distribution, and the distributed content blocks are respectively transferred by said members to some or all members of receiver group in need of contents.

Exchange means within a group, members transfer contents with each other. Specifically, the content blocks transferred from transfer group are exchanged again by members of receiver group to other members in the group.

Node-process refers to process of tasks on nodes, which is specific operation of nodes on G2G computing. Tasks assigned by the group to member nodes can be completed though node-process, including process on use of received contents by this node, such as information archiving, or information presentation to users. Generally, there are two modes to arrange Node-process operation. One is task assigned by job scheduling, and the other is task set by users, such as video program selected by users to watch. Task process can be assigned to transfer by job scheduling, and can also be local program resources of nodes.

Transmutation refers to obtaining new information by processing on received information. Tasks of Transmutation include but not limited to the following ones.

Transmutation operation is to transmute contents (such as abstract, segment, reworking), or to obtain information related to contents.

Transmutation operation is re-operation based on input contents (data) and Node-process results of each node as initial data.

Transmutation operation can be processed before transferring, which means a part of Transmutation is processed on each node. Transmutation can also be processed after results or status of Node-process is returned to appointed groups or nodes. Results of Transmutation can be data sets. If parts of Transmutation are processed on nodes, each node may employ pre-set methods, such as immediate transfer or wait command transfer, asynchronization or synchronization and so on, contents that have been computed are transferred by each node to the transfer group or to next assigned (computing) group as new contents. No matter it is the result of Transmutation or Node-process, Transfer and Exchange also can be the transfer method employed, that is G2G transfer.

There are a transfer module (frame 124) and a task module (frame 126) in scheduling layer.

Transfer scheduling usually depends on the real-time updated control data set, and for achieving controllable transfer and using the whole transfer power as much as possible, the maximum uploading rate that can be used by each node for content transfer, as well as the overall upload bandwidth provided by the receiver group and the transfer group are taken into full account while scheduling.

It can be considered that the basic conditions for G2G content distribution are as follows.

(U₁+ . . . +U_{N})+L*D≧f(N,D)

Uⱼ≦MUⱼ,Uⱼεreceiver group, (j=1, 2 . . . N)

L*D≦U_{S-max}

D≦Dₘₐₓ

Wherein, MUⱼ is the maximum uploading rate that can be used by the node j in the receiver groups for content uploading. Uⱼ is the uploading rate selected for the node j, j=1, 2 . . . N. N is the number of nodes in receiver group. U_{S-max} is the maximum bandwidth provided by source-end. Dₘₐₓ is the most value of the content stream. f (N,D) is downloading bandwidth needed by the receiver group for content downloading. L*D means that member in source-end together provide L times D rate content streams.

By selecting uploading rate for each node and assigning uploading rate for source-end, or by changing one or more parameters of L, D and each node Uⱼ in basic conditions satisfied with G2G content distribution, all kinds of content distribution can be implemented. When applying to transfer scheduling this kind of transfer method can be described as follows.

A kind of transfer scheduling that each node participates in uploading service based on appointed uploading rate is used, wherein, the appointed uploading rate is the maximum rate used by nodes for content uploading, the maximum uploading rate the receiver group can provide and the uploading rate source-end can provide. Effective selections of uploading rate Uⱼ for a node are that when MUⱼ≦D_{avg}, Uⱼ=MUⱼ is selected, and when MUⱼ>D_{avg}, Uⱼ should satisfies Uⱼ≧D_{avg}, and wherein, D_{avg} is the average content uploading rate of each node in the group, that is U_{avg}=(f(N,D)−L*D)/N, and MUⱼ is the maximum rate of the node j for content uploading.

Similarly, job scheduling, which is based on the real-time updated control data set, can judge whether there are enough resources for task request now and in the near future to arrange or refuse tasks according to a user's authority and task requirement and referring to the control data set.

According to its attributes, each user can play one or more roles. For example, users have rights to assign tasks and obligation to carry tasks.

Job scheduling can be transferred to nodes for negotiation with each other. But more applications are managed through servers.

Application layer comprises many tools 130, such as interactive submitting and monitoring tasks, many specific applications 132, such as distributed computing (applied in science research, finance and so on), streaming media, content and file sharing, as well as communication and cooperation systems, and many services 134 etc.

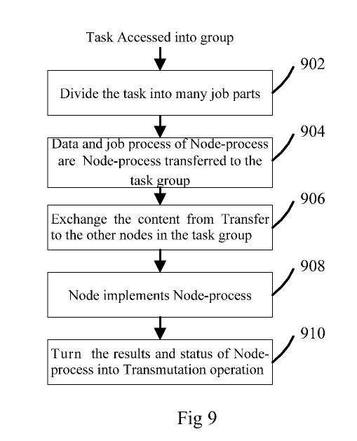

FIG. 9 is a flowchart of an embodiment of the G2G computing on a computing task comprising the following steps.

In step 902, tasks assigned to the groups are divided to many job parts, and then perform step 904.

In step 904, the contents of job parts, including data, the task program Node-process, are transferred through Transfer operation to the task groups, and then perform step 906.

In step 906, when contents transferred to each node in step 904 are incomplete, Exchange is needed to exchange these contents to complete them, and then perform step 908.

In step 908, the task program Node-process is executed, and perform step 910.

In step 910, when Node-process is finished or is necessary to return, Transmutation operation is turned to. Transmutation can be processed before transferring, which means a part of Transmutation operation is processed on each node. Transmutation operation can also be processed after results or status of Node-process is returned to appointed groups or nodes, by means of Transfer and Exchange.

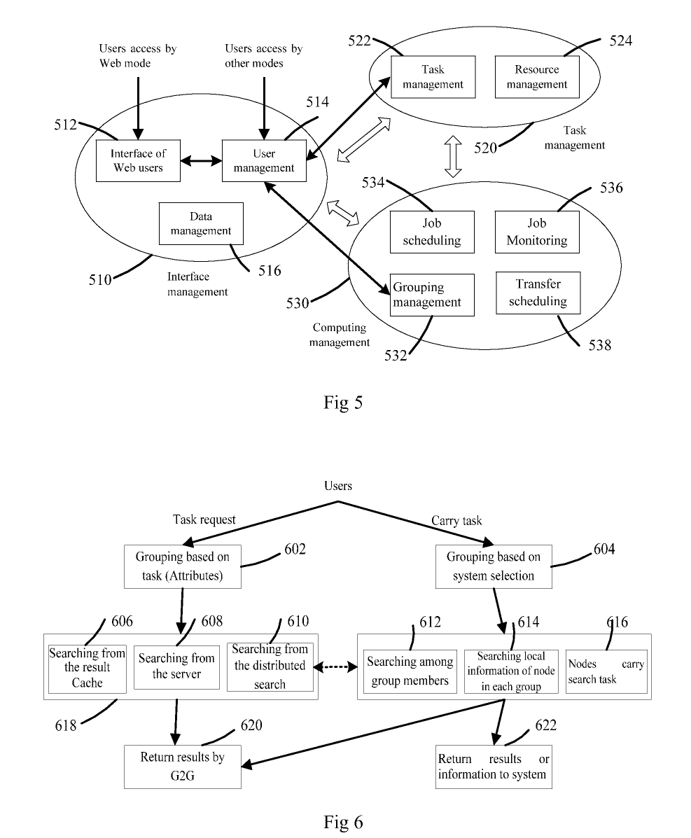

FIG. 5 is a block diagram of an embodiment of a kind of G2G computing service structure based on the G2G computing according to the present invention. The management system comprises three parts of interface management 510, task management 520 and computing management 530.

Users can access G2G computing service by logging in servers, especially by Web interface. As a way to present G2G access, G2G portal is an entrance to G2G computing of end users. G2G portal, through which users can submit tasks, monitor task running, manage and transfer data, query G2G resources information, meanwhile, G2G portal has functions like user management and using of G2G network resources accounting etc.

Interface management comprises Web user interface module 512, user management module 514 and data management module 516.

Interface management provides two modes for users to enter the G2G computing, which are interactive Web mode and other communication modes. Through both two modes users finally access user management module.

G2G portal has a function of submitting interactive tasks, mainly in form of Web page, which is mainly implemented by Web user interface module, usually comprising the following parts.

User part for registration, data modification, login, authentication, etc;

Job part for task definition, submitting, status query, deletion and result acquisition;

Data part for data uploading, downloading and updating;

Information part for node and its status query, service and status query.

User management module manages users that access the system and tasks that users request and carry, and users that access by Web mode and some other modes, which means other communication modes to access systems instead of Web mode of this system.

Grid is usually regarded as similar to working mode of electronic public facilities, in which the location of generators, as well as the way of power network connection is unknown, and when needed, the power can be obtained. Grid is in such a way that, when computing is needed, it can be obtained from grid. But singly from this aspect, many grids separates users from providers, which means, users use high performance computing power provided by providers. Different from the G2G computing, users can play a lot of roles, which can be single assigning computing tasks or carrying G2G computing, or with both obligation to carry tasks and rights to assign tasks.

Different from the general resource using accounting modes, to encourage users to carry computing tasks, the G2G computing network usually adopts encouraging accounting modes, such as providing users carrying more computing tasks with higher priority to use G2G computing network.

As users can play a lot of roles, when assigning tasks, users assign tasks to the task management module, and when able to implement G2G computing, users access the grouping management module.

By user management, users access the grouping management (module) and the task management (module) according to different roles.

The data management module is mainly for management of all kind of storage resources and file data in the G2G computing environment.

Task management part comprises the task management module 522 and the resource management module 524.

Computing management part comprises the grouping management module 532, job scheduling module 534, job monitoring module 536 and transfer scheduling module 538.

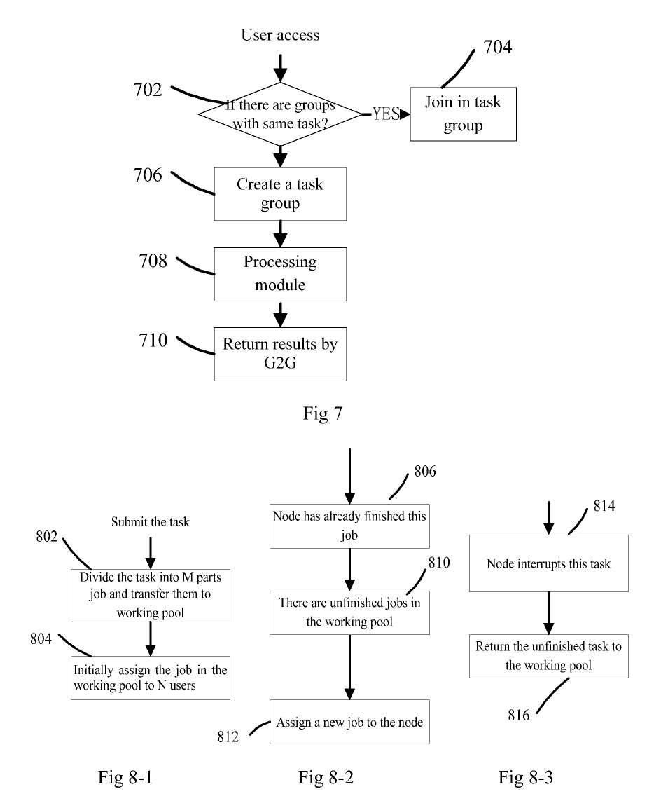

When accessing the task management module 522 for task assigning, users can also be managed through grouping. Seen in FIG. 7, When user access, perform step 702 of finding whether there is a group with the same task. If there is, then perform step 704 of joining this group, or else perform step 706 of creating a new group. Then perform step 708 of processing tasks by taking groups as units, and in step 710, results are returned to users by means of G2G transfer. This can avoid the same repetitive computing and another advantage is that the need for server bandwidth is reduced as results are returned to users by means of G2G transfer.

The resources can be many kinds of software and hardware installed in computing nodes, and also scientific instrument equipments. Each computing node can be set as a resource management unit, mainly based on group resource management. There are two kinds of grouping, one of which is based on basic attributes and the other is based on tasks. As a matter of fact, most rules of grouping management of the computing management part are constituted by the resource management module.

Resource management provides two functions, one of which is constitution of grouping management rules, and the other is the registration, query, browsing, discovering and monitoring function of the resource and assisting the processing module in task manager in resource requirement query.

When there is a task request, the task management searches whether there are enough resources for task request now and in the near future. If there are not, then the task request will be refused, and if there are now, then the task request will be instantly submitted to job scheduling, and if there will be in the future, then the task request will be kept in waiting queue.

Generally, before submitting a task, task management need to apply to resource management for registering a carrying task group, comprising task description and resource requirement for resource distribution convenience and specific arrangement of grouping management.

G2G grouping is based on attributes, which can be one or many, and also be basic attributes or combined attributes. According to this characteristic, a node can belong to one or more groups. For example, receiving content A is a basic attribute, receiving content B is another attribute, and receiving content A and content B at the same time is a combined attribute. A group of members can form a group with the attribute of receiving content A, also a group with the attribute of receiving content B, and also a group with the attribute of receiving both content A and content B at the same time.

For processing convenience, the situation that a node belongs to many groups is simply defined as below.

A node can not belong to two groups with completely the same attributes at the same time. For example, there are attribute A and B, and three groups G1, G2 and G2 which respectively comprise attribute A, A and A+B, and then a node can not belong to both G1 and G2 at the same time, but can belong to G1 and G3 at the same time, for G3 has one more attribute B than G1, so attributes of G3 and G1 are partly the same.

A node can not belong to two groups which conflict with each other. For example, there are two groups G1 and G2 with the same attributes except that they are distinguished according to different periods, and then a node can not belong to G1 and G2 at the same time.

Therefore, a node can be a member of groups for assigning task and also of groups (job groups) for carrying task. For management convenience, a node usually belongs to one or more management groups, which can be referred to as resource groups to be distinguished from task groups. So resource management also needs to establish deployments on how to form and manage resource groups.

It is to be noted that group maintenance will cost. Especially in dynamic network environment, group maintenance costs more. So the job group and the resource group can not be sub-divided too extensively, and “enough” and “appropriate” solutions should be seek.

Users carrying tasks firstly access the grouping management module 532 in computing management part, and then are grouped to corresponding groups based on attributes of nodes (tasks are also attributes). Logically, users need to register the related resources of nodes to resource management, but usually a registration of resource on the group control data set is enough, which is then reflected to resource management by the control data set.

It should be noted that when attributes, such as task or status change, users that belong to some group can become members of another group. Users can join in one or more resource groups appointed by resource management, or only wait in the resource group if there are no proper groups. It should be note that, not every time the user enter into the grouping management, he/she will join in the task group at once due to there may be no task group or no proper task group.

Therefore, once resource management notifies a need for a new task group, grouping management immediately find appropriate nodes from the resource group to form the task group. Hereafter, grouping management need maintain these task groups, including nodes joining in and exiting out as well as status changing.

The scale of management is mostly established by the resource management module, so a task can be easily assigned to the specific groups. When the task management module submits the task, job scheduling further allocates the task, which can be finished by one group, and certainly, this kind of groups can comprise many sub-groups, which is somewhat similar to hierarchical management. In addition, the task can be divided to many parts, which are respectively completed by many groups. No matter in which ways mentioned above, job scheduling comprises group job scheduling.

There are many advantages of group job scheduling. Firstly, all resource status of a group can be clearly known through the control data set, which makes tasks assignment easier. Secondly, based on real-time job monitoring of the control data set, real-time modification on the task for environment adaptation can be easily completed by assistance job scheduling. Finally, a group with the same attributes is more cooperative to finish a common task.

The group job scheduling module 534 usually divide a task assigned to the group into many parts, which are assumed to M. If the number of the group members is N, then make M=N. But it should even more make M greater than N, or be many times of N. In this way, groups can be more cooperative to finish the task and more adapted to dynamic network environments, for nodes join in and exit out dynamically.

The job monitoring module 536 provides job status of each node to job scheduling, by means of returning results through Transmutation, or regularly querying job status by the job monitoring module to nodes.

The transfer scheduling module 538 implements transfer scheduling in the G2G computing.

FIG. 8-1 is a flowchart of job scheduling in an embodiment according to the present invention. After a task is submitted, perform step 802 that job scheduling divides the task submitted into M parts of job, and then transfers them to working pool. Then perform step 804 that tasks in working pool is initially distributed to N members of the group, during which nodes need to meet the requirements of the task, or seek the appropriate task for nodes. In step 802, when nodes need to meet the requirements of the task, there are two distributing modes below.

A5, distributing a part of tasks to each node.

B5, distributing an unequal amount of tasks depending on the amount of node resources.

Without considering costs of communication between job scheduling and nodes, the mode A5 and B5 can achieve the same effect, that is, nodes with more resources are likely to complete the task faster, so they can process more tasks. From another aspect, by the mode B5 communication cost can be reduced.

Preferred implementing schemes of job scheduling for distributing task parts to the nodes are that a group presets a time threshold t, and when the average time spent on processing a task part by the group members is larger than t, distributing mode A5 is selected for the group, or else distributing mode B5 is selected.

Job scheduling transfers the distributed task parts to the nodes to implement, and implementing flow is showed in FIG. 8-2, 8-3.

In step 806, if a node has already finished the present task, then perform step 801 of making sure whether there are unfinished tasks in the working pool, and if there are, perform step 812 that job scheduling will continue to distribute new tasks to the node in one of two distributing modes in step 802.

In step 814, if a node interrupts the task, then perform step 816 of returning the unfinished task to the working pool.

Actually, all computing management is related to four basic operations of the G2G computing. After being assigned to a task group, a task is divided to many job parts, which then are respectively assigned to nodes to implement computing. Assigning to nodes to implement computing until getting results depends on four basic operations, that is, through Exchange and Transfer, the job part transfers job data and related program Node-process that needs to be transferred to nodes, and then task computing is implemented. If Node-process need not be transferred, then local program resources of nodes are selected. Computing results are returned to the appointed group through Transmutation, which can also be a part of job monitoring.

According to a user's authority and task requirement and referring to the control data set, job scheduling can arrange or refuse tasks based on the real-time updating control data set. Nodes in a group can assign tasks to each other, and nodes have rights to assign tasks and obligation to carry tasks.

FIG. 6 is a block diagram of an embodiment of a kind of G2G search service structure based on the G2G computing according to the present invention.

When accessing the G2G search service, according to task requirement and carried tasks, users respectively or simultaneously access step 602 of grouping according to tasks (attributes) and step 604 of grouping according to system selection with different roles. Through distributing according to tasks (attributes), users join in or create a specific request for querying task group. Through distributing according to system selection, users join in the resource group they belong to, and when there are tasks to carry, users join in the specific carrying task group.

After users access step 602 of grouping according to tasks (attributes), perform step 618 that the requesting query task group to implement query, according to different policies, which can be set by the users, or adopted by the system depending on specific situation. These policies include:

Step 606 of searching from the result Cache;

Step 608 of searching from the information server;

Step 610 of searching from the distributed search.

Said result Cache is a collection of searched contents that are once recently requested by users to the G2G search service and with results. Result Cache has a time limit, and if there are no needed contents in result Cache, other policies will be further adopted for query. Policy A3 can avoid the same query.

The result cache, which is not limited to specific storage modes, can be the computer memories, hard disks, as well as other storage systems.

Policy B3 refers to searching from the centralized information server in the G2G search service. Contents in the information server are searched out by the G2G search service system and though many methods, including contents searched out through the G2G search.

Policy C3 provides the G2G distributed search service to users, and assigns requesting query to the specific carrying task group to implement search tasks.

In preferred embodiment, perform step 620 of returning query results by the query task group to members in the query task group.

After user accesses step 604 of grouping carried tasks according to system selection, there are three following modes for users to carry tasks.

Step 612 of searching among group members;

Step 614 of making query on local related contents of nodes;

Step 616 of completing appointed search tasks assigned by the system in appointed search space.

As a matter of fact, all members in the G2G network can query other member in the group, unless specially restricted. However, as a part of the G2G distributed search service, the method A4 is also has other significance, that is, the system can assign some member in the group to implement query to the group.

When carrying a task, a user becomes a node in the G2G network, which can be searched out by other users through the G2G network. Depending on the preset conditions, the G2G search service can search local related contents of the node that permitted for searching. Local search programs can be an inherent part of the G2G search system, and also the third-party local search engines of the node.

By the mode C4, the G2G search service assigns users to participate in the search job, that is, partake tasks that is previously searched through non-distributed search, such as processing tasks as what network search robots or network spider programs do. The returning of search results can be performed by step 622, that is, return the search results to the center server wholly or after processing, or also returning corresponding index only and with search results saved locally to form a distributed storage network.

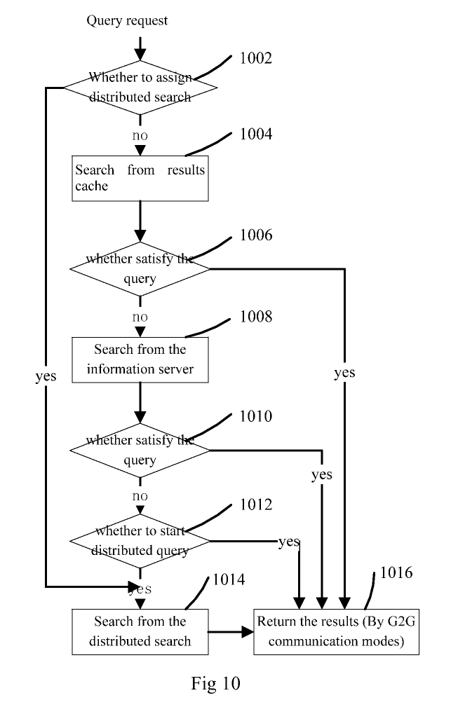

FIG. 10 is a flowchart of query request first execution in an embodiment of the G2G search service structure based on the G2G computing according to present invention. When there is a query request, firstly perform step 1002 of judging whether it is an appointed distributed query. If it is, then perform step 1014 of searching modules through distributed search, and if it is not, perform step 1004 of executing query from the result Cache in the default way.

After searching out the results from the result Cache, perform step 1006 of judging whether these results can satisfy the query request. If they can, perform step 1016 of returning the results through G2G communication, and if they can not, then perform step 1008 of executing query from the information server.

After searching out the results from the information server, perform step 1010 of judging whether these results can satisfy the query request. If they can, perform step 1016 of returning the results through G2G communication, and if they can not, then perform step 1012 of judging whether the distributed query is needed. If it is needed, then perform step 1014 of searching modules through distributed search, and if it is not needed, perform step 1016 of returning the results searched out from the result Cache and the information server. At this moment, the result may be empty.

The conditions of judging whether the distributed query is needed are: (1) according to users' appointment that need or not; (2) according to preset rules by the system.

After execution of searching modules through the distributed search, results are returned through G2G communication. Said results may be searched out through the distributed search, or the results searched out both from result Cache and the information server.

Terms like “comprise”, “have” and “include” are regarded as extensive terms (that means comprising but not limited to), unless specifically described. Examples or demonstrative words (such as “for example”) are used only to describe this invention better, not to restrict the scope of the present invention, unless specifically described. This invention has been introduced for purpose of description and demonstration, which does not mean that it is exhaustive or limited to what has been demonstrated. To avoid that one ore more invention will be difficult to understand, the description may omit some information already known by one skilled in related art. For common one skilled in related art, many modification and changes will be obvious. For example, these steps can be performed in different orders, or some of them can be added, deleted and modified. All of these changes are regarded as a part of this presented invention.

What is claimed is:

1. A method of group-to-group computing, which carries a task by taking groups as units, the group is a collection of nodes with the same attributes, wherein, comprising four basis operations as follows:
Transfer, which means contents that need to be transferred are divided to many blocks, said many blocks are distributed to some or all nodes in the transfer group in charge of transferring said blocks, and said nodes respectively transfer the distributed content blocks to some or all nodes of the receiver group in need of the content block;
Exchange, which means within a group, nodes transfer contents with each other, which including transferring private content blocks to other nodes in the group, or transfer again the content blocks received from the transfer group to other nodes in need of said content blocks in the group;
Node-process, which means process of nodes on assigned tasks;
Transmutation, which means re-reprocess on data after Node-process in each node in the group.

2. The method of G2G computing according to claim 1, wherein, there are job scheduling and monitoring:
for a group in charge of a computing task, job scheduling divides the task into many job parts and transfers the data of job part and related program Node-process that needs to be transferred to related nodes through Exchange and/or Transfer; if Node-process program need not be transferred, then original program resources of nodes are selected, and then task computing is implemented through Node-process, and computing result of the task are obtained by turning the computing results of the Node-process into the Transmutation operation.

3. The method of G2G computing according to claim 2, wherein, said Transmutation is a part of job monitoring.

4. The method of G2G computing according to claim 1, wherein, said attributes comprises at least one of the following items: tasks, contents, network rate, location, distance, delay, node identification, stability and location of starting to receive contents.

5. The method of G2G computing according to claim 1, wherein, a node can belong to one or more groups when assigning the node to a specific group through grouping according to attributes.

6. The method of G2G computing according to claim 5, wherein, the following preset policies are adopted when grouping:
A1, the first precedence is task precedence, and different groups are created for different tasks;
B1, the second precedence is task running status precedence;
C1, the third precedence is other attributes precedence, which including:
C11, the network speed precedence,
C12, the resource attributes precedence,
C13, the stability precedence,
C14, the location precedence,
C15, the delay or distance precedence,
C16, the same node identification attributes precedence;
D1, the number of group members can not be larger than a number preset by the system, and a new group can be created if necessary, and there can be many groups with the same attributes.

7. The method of G2G computing according to claim 6, wherein, without changing the original group, the existing group can be divided to two or more sub-groups.

8. The method of G2G computing according to claim 6, wherein, a control data set is established for each group to record group information, which comprising one or a collection of more than one of:
identification, attributes, policies, tasks, status of groups, as well as resources, attributes of each node, necessary data for inter-communication, node tasks, transfer status and task status.

9. The method of G2G computing according to claim 8, wherein, said control data set can be kept in each node or in a management server so that group members can get the control data set by only one operation.

10. The method of G2G computing according to claim 8, wherein, when data recorded in the control data set change or new data will be added to the control data set, real-time updating is implemented in all control data sets at each position or in all related parts in the control data set.

11. The method of G2G computing according to claim 1, wherein, also comprises transfer scheduling steps of each node to participate in uploading services based on the appointed uploading rate when transferring contents.

12. The method of G2G computing according to claim 1, wherein, said appointed uploading rate is related to the maximum rate used by nodes for content uploading, the maximum uploading rate the receiver group can provide and the uploading rate the source-end can provide.

13. The method of G2G computing according to claim 12, wherein, a effective selections of uploading rate Uⱼ for a node are that when MUⱼ≦D_{avg}, Uⱼ=MUⱼ is selected, and when MUⱼ≧D_{avg}, Uⱼ selected should satisfies with Uⱼ≧D_{avg}, and wherein, D_{avg} is the average content uploading rate of each node in the group and MUⱼ is the maximum rate of the node j for content uploading.

14. The method of G2G computing according to claim 8, wherein, according to a user's authority and task requirement and referring to the control data set, job scheduling can arrange or refuse tasks based on the real-time updating control data set; nodes in a group can assign tasks to each other, and nodes have rights to assign tasks and obligation to carry tasks.

15. A G2G computing service system based on the G2G computing, wherein, there is at least one machine-readable medium, which possess machine-readable program node logic for implementing G2G computing service, the structure of the G2G computing service system implemented by the machine-readable program node logic comprises:
Management layer, which is in charge of user management, grouping and group information management;
Support layer, which comprises four basic operations of G2G computing: Transfer, Exchange, Node-process and Transmutation;
Scheduling layer for transfer scheduling and job scheduling;
Application layer for providing users with development tools, application programs and services.

16. The G2G computing services system according to claim 15, wherein, said G2G computing services comprises providing users with portal service of the G2G computing through the portal network site, and said G2G computing services comprises a function of submitting interactive tasks.

17. The G2G computing services system according to claim 16, wherein, said G2G computing services comprises that users can have both obligation to carry tasks and rights to assign tasks.

18. The G2G computing services system according to claim 16, wherein, said G2G computing services comprises providing users carrying more computing tasks with higher priority to use G2G computing network by using encouraging accounting mode.

19. The G2G computing services system according to claim 16, wherein, the G2G computing services comprises that for a group in charge of a computing task, job scheduling divides the task to many job parts, each one part is distributed to each member at first, then another part is distributed to the member who finished the part distributed before sequentially till the task of the group is completed.

20. The G2G computing services system according to claim 16, wherein, the G2G computing services comprises that for a group in charge of a computing task, job scheduling divides the task to many job parts, and initially distributes corresponding job amount to each member according to its amount of resources.

21. A G2G search service system based on the G2G computing, wherein there is at least one machine-readable medium, which possess machine-readable program node logic for implementing G2G search service, the structure of the G2G search service system implemented by the machine-readable program node logic comprises:
Management layer, which is in charge of user management, grouping and group information management;
Support layer, which comprises four basic operations of G2G computing: Transfer, Exchange, Node-process and Transmutation;
Scheduling layer for transfer scheduling and job scheduling;
Application layer for providing users with development tools, application programs and services.

22. The G2G search service system according to claim 21, wherein, said G2G search service comprises providing users with portal service of the G2G computing through the portal network site and a function of submitting interactive tasks.

23. The G2G search services system according to claim 21, wherein, the G2G search services comprises that, in the G2G search services, once accessing the portal of the G2G search service, users access a cooperation search environment, which comprises:
A2, forming a search task group together with other users with the same need of searching;
B2, carrying search services for the search system;
C2, requesting search services.

24. The G2G search services system according to claim 21, wherein, said G2G search services comprise that when the G2G search services provide query information to users, there are one or the combination of more than one of the following search modes:
A3, Searching from the result Cache;
B3, Searching from the information server;
C3, Searching from the distributed search.

25. The G2G search services system according to claim 21, wherein, said G2G search services comprise that when users carry search tasks, there are one or the combination of more than one of the following search modes.
A4, searching among group members;
B4, making query on local related contents of nodes;
C4, completing appointed search tasks assigned by the system in appointed search space.

26. The G2G search services system according to claim 25, wherein, said node adopts the local search engine for local content query of the node, and the local search engine can be an inherent part of the G2G search system, or the third-party local search engine of the node.

27. The G2G search service system according to claim 25, wherein, said G2G search services comprise that when carrying search tasks, group members can process the tasks cooperatively.

28. The G2G search service system according to claim 27, wherein, said G2G search services comprise that results of node search are transferred to the users by G2G transfer.

29. The G2G search service system according to claim 28, wherein, the G2G searching services comprise that nodes return search results to the system, or save results in the storage system of the nodes and return the index to the system.

30. A machine-readable medium, wherein, is provided with computer executable instructions according to said method in claim 1.
